(19) United States
(12) Patent Application Publication
(10) Pub. No.: US 2003/0046605 A1
(43) Pub. Date: Mar. 6, 2003

(54) Data protection system and method regarding the same

(75) Inventor: Simon Qin, Chongging (CN)

Correspondence Address: HOGAN & HARTSON L.L.P., 500 S. GRAND AVENUE, SUITE 1900, LOS ANGELES, CA, 90071-2611, US

(73) Assignee: FarStone Technology Inc.

(21) Appl. No.: 10/115,630

(22) Filed: Mar. 28, 2002

(30) Foreign Application Priority Data
Sep. 3, 2001 (TW) 90121811

(51) Int. Cl. G06F 11/00

(52) U.S. Cl. 714/13

(57) ABSTRACT

A data protection system and methodology that securely protects data in a computer system, so that a backup/recovery program will never be destroyed. According to the invention, the data protection system comprises a read only storage device and an operating system. The read only storage device is used for storing data needed by the computer system over a long period of time. The operating system is used for controlling operations of the computer system and managing the read only storage device. In one embodiment of the invention, the read only storage device has a backup/recovery means and a driver. The backup/recovery means can back up the data in the computer system and restore the computer system to a previous state. The driver can drive the backup/recovery means to back up the data and restore the computer system.

### BACKGROUND OF THE INVENTION

1. Field of the Invention

The present invention relates generally to a data protection technique for a computer system, and more particularly to a data protection system having a backup/recovery program that can be securely protected in order to ensure that the backup/recovery operation of the computer system can be adequately performed by the data protection system.

2. Description of Prior Art

Conventional backup/recovery techniques often establish recovery points to backup data in a computer system for restoring the computer system to a state of establishing the recovery points. These backup/recovery techniques can be generally classified into two types. The first type is a static backup/recovery technique, and the second type is a dynamic backup/recovery technique. Backing up data with the static backup technique can normally store the backed-up data over a long period of time. In contrast, the dynamic backup technique has the advantage of using the storage space of a hard disk of the computer system in a more effective way when backing up the data.

Conventional backup/recovery software can also be classified into a static backup/recovery type software and a dynamic backup/recovery type software. The static backup/recovery type software, such as the Ghost software developed by Symantec Corporation, adopts a static backup technique in establishing recovery points during the data backup process. And the dynamic backup/recovery software, such as the Goback software developed by Adaptec Corporation and the Pro Magic software developed by WASAY Incorporation, adopts a dynamic backup technique in establishing recovery points during the data backup process.

Such Ghost software developed by Symantec Corporation backs up all valid data of those data being in a state of maintenance. Accordingly to the conventional backup/recovery software, backing up data by this static backup technique takes up fixed storage space of the hard disk in the computer system. Moreover, the backed-up data is kept in a state of perpetuity, independent of other current or future data contained in the hard disk of the computer system.

When the static backup/recovery program is executed to back up data, all data stored in selected partitions of the hard disk is backed up to a file. In addition, when the static backup/recovery type program is executed to recover data, the data from the previously backed up file is restored to the selected partitions of the hard disk.

Such Goback software developed by Adaptec Corporation or Pro Magic software developed by WASAY Incorporation restore the computer system to a previous state, in accordance with the backed up data, from a current state. The valid data is backed up prior to making changes to the data. The backup file contains the backup data and identification information to identify the backup data. Such identification information is useful in restoring the computer system in the future.

Although the conventional backup/recovery software has the backup/recovery capabilities to back up and/or recover data in the hard disk, the recovery operation is often failed using the current conventional backup/recovery techniques. The reason is that the conventional backup/recovery software is installed in a writeable medium, such as the hard disk or a floppy disk. Accordingly, the conventional backup/recovery program, together with the backed up data, may be damaged during operations of the computer system. If so, the recovery operation is impossible to restore the computer system to any previous state.

The Recovery Genius product developed by GoldenSoft in does not install its backup/recovery program into a writeable medium, but into an unwriteable medium. Nevertheless, its backup/recovery product often cannot work properly either, as will be explained below. Moreover, the Recovery Genius product often causes the problem of the operating system (OS) incapable of working normally thereby.

The Recovery Genius product supports a few operating systems (OS), a 32-bit OS for example, respectively contained in a computer system. Each of the operating systems is additionally provided with a specific driver contained therein for driving the Recovery Genius. The specific driver is a part of a driver program of the Recovery Genius product. After the operating system is running, such specific driver will be loaded and carried out as a part of the operating system. There are two main problems of this Recovery Genius product. One is that the backup/recovery product cannot work properly if the requisite driver is not provided for the operating system. As the other is that such backup/recovery product must provide the various operating systems, such as the Windows 98, the Windows NT, the Windows 2000, or the Linux, with the corresponding drivers, respectively.

Prior to the backup/recovery operation, the Recovery Genius product first stores a backup/recovery program and a setup program into a read only memory (ROM) when it is manufactured. At this time, the driver has not been copied into the operating system yet. Therefore, the Recovery Genius product cannot yet execute the backup/recovery operation as well.

The setup program is used to setup the driver for the operating system. After starting up the operating system, the operating system runs the setup program to copy the driver therein. The driver can thereafter drive the Recovery Genius product to execute the backup/recovery program. Owing to the driver provided by the Recovery Genius to the operating system, the operating system (OS) can work properly in backing up and/or recovering data.

The specific type of the driver for the Recovery Genius depends on what the operating system is installed in the computer system. However, data in the hard disk is easy to be destroyed and so is a program stored in the hard disk. As a result, the driver of the Recovery Genius product is also prone to be damaged. In the case the driver of the Recovery Genius product is destroyed, the Recovery Genius product will no longer work properly. The computer system, thus, cannot be protected under the control of the Recovery Genius' backup/recovery program.

In the meantime, the operating system of the computer system cannot work properly as well. Because of the Recovery Genius product, the operating system cannot run normally, provided that the driver is destroyed. The reason is that the driver and the OS are mutually dependent after the driver is stored into the OS.

The Windows driver for the backup/recovery program should be contained in a designated list of the Windows operating system stored in the hard disk. Alternatively, the location where to load the driver should be specified in a Windows Registry. The location of the driver should be contained in a Windows file system stored in the hard disk for the Windows to load the driver in the operating system.

The program code of the Recovery Genius is burnt into a ROM of the computer system. When the data is needed to be backed up or restored, the Recovery Genius product performs the program code in the ROM. ROM is a costly resource, whereas the program code of the Recovery Genius product takes up a large amount of storage space in the ROM. Therefore, the Recovery Genius product is generally not attractive to many users.

### SUMMARY OF THE INVENTION

The present invention provides a data protection system and method to resolve the foregoing problems faced by the conventional backup/recovery software. The present invention also has the advantage of high stability and reliability. The occupied storage space by the backup/recovery program can be economized relatively. Moreover, the backup/recovery program is ensured from being damaged under almost any conditions so as to back up and/or restore data for the computer system.

An object of the present invention is to provide a data protection system and method, wherein a static backup/recovery technique, a dynamic backup/recovery technique, an integrated backup/recovery technique, or the like, can all be adopted in the data protection system.

Another object of the present invention is to provide a data protection system and method, which can eliminate the operation dependence on the operating system, to achieve the independent character and reliability.

Moreover, according to the present invention, the ROM storage space is economized by a wide margin in order to substantially save the ROM storage space up to 50%.

In accordance with an aspect of the present invention, a data protection system is used for protecting data in a computer system. The data protection system includes a read only storage device. A read only storage device is used for storing data needed by the computer system over a long period of time. The operation system (OS) of the computer system controls the operations of the computer system and manages the read only storage device. The read only storage device has a backup/recovery means and a driver. The backup/recovery means backs up the data in the computer system and restores the computer system to a state immediately prior to backing up the data in the computer system (the previous state). The driver drives the backup/recovery means to back up the data and restore the data to the computer system.

In the preferred embodiment of the invention, the operating system can be Windows 9x (Window 95, Window 98, Window Millennium, etc.), Linux, Windows NT, Window 2000, Window XP, Mac OS, or the like. The read only storage device can be read only memory (ROM), flash memory, Programmable Read Only Memory (PROM), Electrically Erasable Programmable Read Only Memory (EEPROM), Erasable Programmable Read Only Memory (EPROM), mask read only memory (mask ROM), or the like. The backup/recovery means may further contain a detecting module for monitoring a predetermined message in order to determine whether the backup/recovery means to back up data or not. The backup/recovery means may back up all valid data within the computer system. For example, the backup/recovery means may back up valid data being changed (the temporary data) or valid data in the state of maintenance within the computer system. The backup/recovery means may include an inspecting module for inspecting any input from an user automatically when power up for the computer system. The inspecting module may provide a selecting interface for the user to decide whether to execute a backup/recovery operation or not. The backup/recovery means may comprise a compressed portion to compress the program codes of the backup/recovery means and the driver. The backup/recovery means may comprise a decompression utility configured for decompressing the compressed portion. The decompression utility can decompresses the compressed portion to a random access memory (RAM) prior to the backup/recovery operation.

In accordance with another aspect of the present invention, a read only memory is suitable for a computer system to store data needed by a computer system over a long period of time. The read only memory comprises a backup/recovery module and a decompression code. Prior to being stored in the read only memory, the backup/recovery module is under a pre-compressed treatment. As a result, the backup/recovery module occupies only a small storage space in the read only memory. The decompression code is used for decompressing the backup/recovery module to a data storage device prior to execution of the backup/recovery module.

In the preferred embodiment of the invention, the data storage device is a random access memory (RAM), such as a hard disk or a dynamic random access memory (DRAM). The backup/recovery means may include an inspecting module for inspecting any input from the user automatically when power up for the computer system. The inspecting module may provide a selecting interface for the user to decide whether to execute backup/recovery operation or not.

The present invention may best be understood through the following description with reference to the accompanying drawings, in which:

### BRIEF DESCRIPTION OF THE DRAWING

FIG. 1 is a schematic block diagram of a data protection system of a preferred embodiment according to the present invention.

FIG. 2 is a graphical representation of a ROM with a backup/recovery module of the preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new data protection system with a virtually non-destructible backup/recovery utility, which can serve users' demands much more adequately. No setup program is required, nor any program should be added to the OS. The data protection system can implement the backup/recovery function and the OS can be operated in the best mode in almost any event. Moreover, the storage space of the ROM can be more effectively utilized. Accordingly, the problem of slowdown, unstable operation, and frequent crash of the computer system owing to insufficient memory commonly experienced by conventional backup/recovery program can be solved. The protective capability and the efficiency of the described data protection system can also be increased.

With the data protection system of the present invention, the backup/recovery program will not be destroyed. In addition, the backup/recovery operation can be properly performed in all conditions no matter what OS is installed in the computer system. The backup/recovery program may be compressed in order to economize on storage space occupied by such program. Therefore, the drawbacks faced by the conventional backup/recovery program, such as the Recovery Genius, can be solved completely.

According to the preferred embodiment of the present invention, a data protection system is used for protecting data in a computer system. The data protection system includes a read only storage device. A read only storage device is used for storing data needed by the computer system over a long period of time. The OS of the computer system controls the operations of the computer system and manages the read only storage device. The read only storage device has a backup/recovery means and a driver. The backup/recovery means backs up the data in the computer system and restores the computer system to a previous state. The driver drives the backup/recovery means to back up the data and restore the data to the computer system.

The operating system can be Windows, Linux, Windows NT, Mac OS, or the like. The read only storage device can be a read only memory (ROM), a flash memory, a Programmable Read Only Memory (PROM), an Electrically Erasable Programmable Read Only Memory (EEPROM), an Erasable Programmable Read Only Memory (EPROM), a mask read only memory (mask ROM), or the like. The backup/recovery means may further contain a detecting module for monitoring a predetermined message when the predetermined message is retrieved, in order to determine whether the backup/recovery means to back up data or not. The backup/recovery means may back up all valid data within the computer system. For example, the backup/recovery means may back up valid data being changed (the temporary data) or valid data in the state of maintenance within the computer system. The backup/recovery means may include an inspecting module for inspecting any input from a user automatically when power up for the computer system. The inspecting module may provide a selecting interface for the user to decide whether to execute a backup/recovery operation or not. The backup/recovery means may comprise a compressed portion to compress the program codes of the backup/recovery means and the driver. The backup/recovery means may comprise a decompression utility configured for decompressing the compressed portion. The decompression utility can decompresses the compressed portion to a random access memory (RAM) prior to the backup/recovery operation.

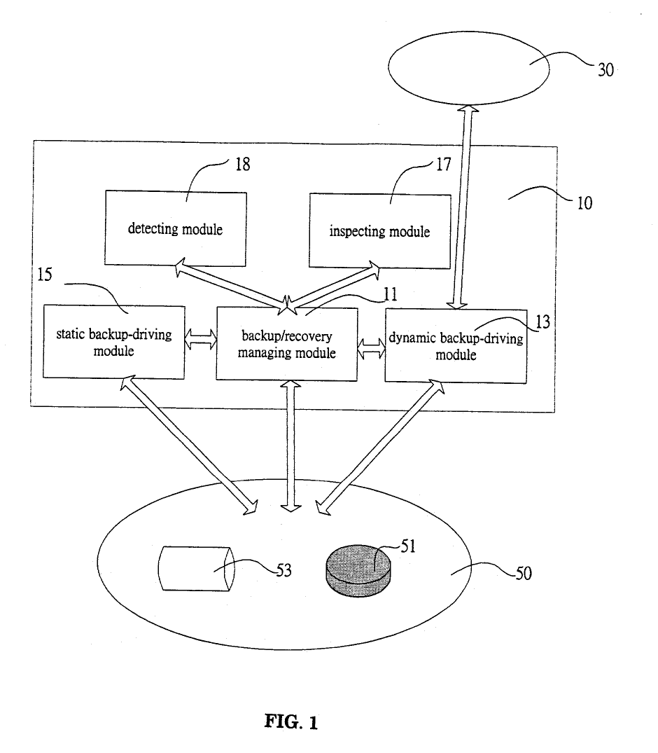

Referring to FIG. 1, a schematic block diagram of a data protection system of a preferred embodiment according to the present invention is shown. The data protection system of the present invention is suitable for a computer system, which can protect data in the computer system. The data protection system includes at least a read only storage device 10. The computer system includes an operating system (OS) 30 for controlling and managing the computer system.

The OS 30 is used for controlling operations of the computer system and managing the read only storage device 10. The OS 30 further provides a user interface (UI), through the UI, the users can enter commands/information into the computer system. The OS 30 is used for controlling operations of the computer system can be Windows, Linux, Windows NT, Mac OS, or the like.

The read only storage device 10 is used for storing data needed by the computer system over a long period of time. The read only storage device 10 has a backup/recovery means and a driver. The backup/recovery means backs up the data in the computer system and restores the computer system to a previous state. The driver can drive the backup/recovery means to back up the data and restore the computer system. The read only storage device 10 can be a read only memory (ROM), a flash memory, a Programmable Read Only Memory (PROM), an Electrically Erasable Programmable Read Only Memory (EEPROM), an Erasable Programmable Read Only Memory (EPROM), a mask read only memory (mask ROM), or the like.

The backup/recovery means of the read only storage device 10 may contain a backup/recovery managing module 11 and an inspecting module 17. The driver of the read only storage device 10 may contain a dynamic backup driving module 13 and a static backup-driving module 15.

The backup/recovery means may further contain a detecting module 18 for monitoring a predetermined message when the predetermined message is retrieved, in order to determine whether the backup/recovery means to backup data or not.

The backup/recovery means may comprise a compressed portion to compress the program codes of the backup/recovery means and the driver. The backup/recovery means may comprise a decompression utility configured for decompressing the compressed portion. The decompression utility can decompresses the compressed portion to a random access memory (RAM) prior to the backup/recovery operation.

The backup/recovery managing module 11 is used to manage the backup/recovery operation. It may adopt a static backup/recovery technique, a dynamic backup/recovery technique, an integrated backup/recovery technique, or any other available backup/recovery techniques, so that the users' satisfactions with backing up and/or recovering data can be adequately met.

The inspecting module 17 has an inspecting routine, which can inspect any input from a user automatically when power up for the computer system. The inspecting module 17 may also provide a selecting interface for the user to decide whether to execute backup/recovery operation or not.

The dynamic backup-driving module 13 is responsible for driving the backup/recovery managing module 11 to perform the dynamic backup/recovery operation. If the dynamic backup/recovery managing module 11 of the data protection system is directed to perform the backup operation, the valid data of the temporary data is backed up prior to making changes to the data. Generally speaking, there is not much change of such data so that the data amount to be backed up will be relatively small. Accordingly, the storage space that will be occupied by the backup data in a random access memory can be reduced, and the required process time for restoring the computer system from a current state to a previous state will also be short.

The static backup-driving module 15 is responsible for driving the backup/recovery managing module 11 to perform the static backup/recovery operation. In a situation of independent operation from the current data of the hard disk, the data in the hard disk can be backed up and kept in a state of perpetuity.

The dynamic backup-driving module 13 backs up valid data being changed within the computer system. The static backup-driving module 15 backs up all valid temporary data within the computer system, i.e., the data that is already stored in the hard disk. As shown in FIG. 1, a backup database 53 for the backup data and the valid data 51, which can be permanent data or can be temporary data, within the hard disk 50 are all stored in the hard disk 50.

The dynamic backup-driving module 13 and the static backup-driving module 15 drive backup/recovery-managing module 11 independently. The data to be backed up can be the valid data already within the hard disk 50, and such can be stored in the backup database 53. At the time recovering the computer system, the data is restored from the backup database 53 to the selected partitions of the hard disk.

The backup/recovery program module contains all programs required for performing the backup/recovery function, which are located in the read only storage device 10 entirely. Therefore, the backup/recovery program module is independent of the OS, the backup/recovery program module can perform every kind of backup/recovery operation properly in any normal operation of the operation system.

The backup/recovery program module with the driver program of its own is no need to include a setup program, for the driver program is stored in the read only storage device 10. Hence, the function of the backup/recovery program module with the driver program of its own and the OS can be operated in the best mode in any event. There is no mutual influence between the operating system (OS) and the backup/recovery program module with the driver program of its own.

The backup/recovery program module doesn't provide the OS with any driver program. Prior to operating the OS, the driver is “hooked up” to the hard disk driver. Thus, any read/write requests from the OS will be monitored by the backup/recovery program module.

The backup/recovery program module is not located in the OS, but in the driver layer of the computer I/O system. Consequently, the backup/recovery program module does not need to provide the different OS, such as Windows 9x, Windows NT, Windows 2000, Window XP, Linux, etc., with different corresponding driver programs.

According to the preferred embodiment of the present invention, a read only memory is suitable for a computer system to store data needed by a computer system over a long period of time. The read only memory comprises a backup/recovery module and a decompression code. Prior to being stored in the read only memory, the backup/recovery module is under a pre-compressed treatment. As a result, the backup/recovery module occupies only a small storage space in the read only memory. The decompression code is used for decompressing the backup/recovery module to a data storage device prior to execution of the backup/recovery module.

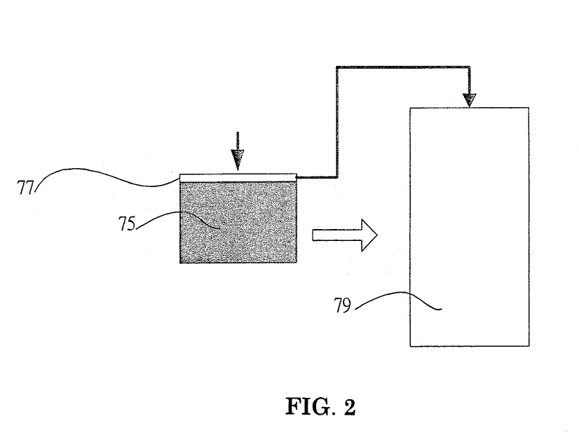

Referring to FIG. 2, a graphical representation of a ROM with a backup/recovery module of the preferred embodiment according to the present invention is shown. According to the present invention, the ROM with a backup/recovery module of the present invention is suitable for a computer system. The ROM can economize on the occupied storage space, which the backup/recovery module stored therein will never be destroyed.

The backup/recovery module 75 and a decompression code 77 are burnt in the ROM. The backup/recovery module 75 may include a backup/recovery program module with a driver program for performing a predetermined backup/recovery function. The backup/recovery module 75 may be compressed prior to being burnt into the ROM. The decompression code 77 is not pre-compressed.

As shown in FIG. 2, the backup/recovery module 75 is performed after being decompressed to the data storage device 79 by the decompression code 77. The data storage device 79 is a random access memory (RAM). The backup/recovery module 75 may include an inspecting module for inspecting any input from a user automatically when power up for the computer system. The inspecting module may provide a selecting interface for the user to decide whether to execute backup/recovery operation or not.

The data protection system of the present invention does not need to add any kind of programs to the OS, so that the backup/recovery module will never be destroyed, thereby achieving the independent character and reliability of the data protection system. The data protection system can economize the occupied storage space greatly, thereby preventing the occupation of the high price resources. Therefore, the drawbacks faced by the prior arts can be solved.

The present invention has the advantage of keeping the backup/recovery module permanently and saving the data storage space that can effectively solved the conventional problems faced by the conventional backup/recovery techniques.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data protection system for protecting data in a computer system operated by an operating system, comprising:
a read only storage element for storing data needed by said computer system over a long period of time, wherein
said read only storage element has a backup/recovery means and a driver, said backup/recovery means backs up said data in said computer system and restores said computer system to a previous state, and said driver can drive said backup/recovery means to back up said data and restore said computer system.

2. The data protection system according to claim 1, wherein said driver comprises a compressed portion.

3. The data protection system according to claim 2, wherein said driver comprises a decompression utility configured for decompressing said compressed portion.

4. The data protection system according to claim 2, wherein said decompression utility decompresses said compressed portion to a random access memory (RAM) prior to said backup/recovery operation.

5. The data protection system according to claim 1, wherein said read only storage element is a read only memory (ROM).

6. The data protection system according to claim 1, wherein said read only storage element is a flash memory.

7. The data protection system according to claim 1, wherein said read only storage element is an Electrically Erasable Programmable Read Only Memory (EEPROM).

8. The data protection system according to claim 1, wherein said read only storage element is a mask read only memory (mask ROM).

9. The data protection system according to claim 1, wherein said backup/recovery means contains a detecting module for monitoring a predetermined message when said predetermined message is retrieved, in order to determine whether said backup/recovery means to backup data or not.

10. The data protection system according to claim 1, wherein said backup/recovery means backs up all valid data within said computer system.

11. The data protection system according to claim 1, wherein said backup/recovery means backs up valid data being changed within said computer system.

12. The data protection system according to claim 1, wherein said backup/recovery means includes an inspecting module for inspecting automatically when power up for said computer system.

13. The data protection system according to claim 1, wherein said inspecting module provides a selecting interface for a user to decide to execute a backup/recovery operation or not.

14. The data protection system according to claim 1, wherein said backup/recovery means comprises a compressed portion.

15. The data protection system according to claim 14, wherein said backup/recovery means comprises a decompression utility configured for decompressing said compressed portion.

16. The data protection system according to claim 14, wherein said decompression utility decompresses said compressed portion to a random access memory (RAM) prior to said backup/recovery operation.

17. A read only memory for storing data needed by a computer system over a long period of time, comprising:
a backup/recovery module, being performed a compression treatment, for executing a backup/recovery operation; and
a decompression code for decompressing said backup/recovery module to a data storage element prior to execution of said backup/recovery module.

18. The read only memory according to claim 17, wherein said data storage element is a random access memory (RAM).

19. The read only memory according to claim 17, wherein said backup/recovery module includes an inspecting module for inspecting automatically when power up for said computer system.

20. The read only memory according to claim 17, wherein said inspecting module provides a selecting interface for a user to decide whether to execute backup/recovery operation or not.
